(19) United States
(12) Patent Application Publication
(10) Pub. No.: US 2010/0048235 A1
(43) Pub. Date: Feb. 25, 2010

(54) Method and Device for Data Capture for Push Over Cellular

(75) Inventors: Zhuo-Ming Dai, Jiangsu (CN); Xiao-Feng Zhu, Jiangsu (CN)

Correspondence Address: MOTOROLA INC, 600 NORTH US HIGHWAY 45, W4 - 39Q, LIBERTYVILLE, IL, 60048-5343, US

(73) Assignee: Motorola, Inc., Schaumburg, IL (US)

(21) Appl. No.: 12/520,656

(22) PCT Filed: Dec. 22, 2006
(86) PCT No.: PCT/CN06/03540

§ 371 Date: Oct. 2, 2009

(51) Int. Cl. H04B 7/00

(52) U.S. Cl. 455/518

(57) ABSTRACT

A system (100) and method (300) for data record and playback for push-over-cellular (PoC) is provided. The method can include receiving (302) a push-to-talk (PTT) key-up from a first mobile device during a group dispatch call, identifying (304) the first mobile device from the PTT key-up to produce a first contact identifier (361), recording (306) data during the PTT key-up until a PTT key-down is received to produce a PTT recorded segment (311), marking (308) the PTT recorded segment with the contact identifier, and storing (310) the first PTT recorded segment to memory. The method steps can be repeated for creating a marked PTT conversation (360). The marked PTT conversation can be played back (230) by contact identifier, or played back (240) by call session. During playback, a contact identifier for each PTT recorded segment can be visually or audibly presented.

### FIELD OF THE INVENTION

The present invention relates to wireless communication systems, and more particularly, to data recording and playback.

### BACKGROUND OF THE INVENTION

The use of portable electronic devices and mobile communication devices has increased dramatically in recent years. Two primary means of voice communication are generally offered in mobile devices: Interconnect and dispatch. Interconnect is a communication mode by which both parties can speak at the same time. It is considered a two-way communication since both parties can talk and listen on a separate talk channel and a separate receive channel. Interconnect communication is also available for three-way calling or group call. In contrast, dispatch mode is a communication mode by which only one party can speak at a time. The other party can only listen until the first party finishes talking. In practice, a push-to-talk (PTT) key is pressed to acquire control of a talk channel. The talk channel is not released until the PTT key is released. Upon release, another participant can acquire the PTT channel. Dispatch mode is also available for three-way dispatch or group dispatch.

Push-over-cellular (PoC) is one mode of operation whereby dispatch communication is enabled over a cellular infrastructure. Selected Dynamic Group Call (SDGC) is a form of dispatch call using PoC. SDGC provides a way for all participating mobile devices to talk to each other as on a group call, but it is characterized by creating the group dynamically. SDGC provides fast call setup and operation that in comparison to traditional 3-way interconnect or conference calling. Similarly, SDGC only allows one participant to talk at a time.

Voice Record (VR) is a mobile device feature that can be used to record an entire SDGBC call. In current practice, the entire call is recorded and stored as a call session. A user can replay the entire call session to hear portions the caller may have missed during the PoC call. However, because the entire call is stored, the user must generally listen to the entire call. The call session is also generally stored by date. Accordingly, the user must also generally know when the call was recorded in order to retrieve the call session. Furthermore, during a PoC group call, such as SDBC, many participants may talk during the call, and the call may last for a long time. Accordingly, the user may have to wait to hear portions of the stored call session during replay. This may cause further frustration if the listener is required to listen to the entire call to hear only one portion of the call.

### SUMMARY

Broadly stated embodiments of the invention are directed to a device and method for marking data recordings during a group dispatch call in push-over-cellular (PoC), and playing back the data recordings based on the markings. The method for PoC can include recording a push-to-talk PTT conversation in PTT recorded segments, identifying mobile devices from PTT key-ups during the PTT conversation, assigning contact identifiers to the PTT recorded segments to produce a marked PTT conversation based on the identifying, and saving the marked PTT conversation to memory. A PTT recorded segment can be a data recording, such as voice or video, between a time of a PTT key-up and a PTT key-release. A contact identifier can identify a mobile device, or a user of the mobile device, performing the PTT key-up. A contact identifier can also include a name of a call session, a time of the PTT recorded segment, or a length of the PTT recorded segment. The contact identifier can be retrieved from push-to-transmit (PTX) data associated with the PTT key-up.

In one configuration, the marked PTT conversation can be sorted by contact identifier, and played back in order of recording. Only the PTT recorded segments that match the contact identifier are played back. This allows a user to play back PTT recorded segments of a particular talker, based on the contact identifier. In another configuration, the marked PTT conversation can be played back in entirety with contact identifiers. The contact identifiers can be visually or audibly presented for each PTT recorded segment during a playback of the marked PTT conversation. For example, a name of a user that corresponds to a PTT recorded segment can be visually displayed. As another example, the name of the user can be pre-appended to the PTT recorded segment to audibly identify the person talking.

One embodiment is a method for call session recording and playback in a push-over-cellular (PoC) system. The method can include receiving a push-to-talk (PTT) key-up from a first mobile device during a group dispatch call, identifying the first mobile device from the PTT key-up to produce a first contact identifier, recording data during the PTT key-up until a PTT key-down is received, marking the data with the first contact identifier to produce a first PTT recorded segment, and storing the first PTT recorded segment to memory. The method steps of receiving, identifying, recording, marking, and storing can be repeated for a plurality of mobile devices on the group dispatch call. The step of repeating can produce a marked PTT conversation having multiple PTT recorded segments each separately marked by a contact identifier.

Playback of the marked PTT conversation can be performed by contact identifier or call session. In playback by contact identifier, the method can include receiving a request to retrieve PTT recorded segments associated with a contact identifier, and presenting the PTT recorded segments for the contact identifier in order of recording in response to the request. In playback by call session, the method can include identifying a call session associated with the marked PTT conversation, and playing back the PTT recorded segments by the call session in order of recording. During playback, a contact identifier corresponding to a PTT recorded segment can be visually or audibly presented. For example, a voice tag can be pre-appended on a PTT recorded segment to audibly identify the contact. As another example, a name of the talker can be presented on a display of a mobile device to identify the person talking.

One embodiment is directed to a mobile device for call session recording and playback suitable for use in push-over-cellular (PoC). The mobile device can include a push-to-talk (PTT) key for acquiring a talk channel and communicating data during a PTT group call, a recorder that records the PTT group call in PTT recorded segments, and a processor that assigns contact identifiers to the PTT recorded segments to produce a marked PTT conversation. A PTT recorded segment can be a recording of data between a time of a PTT key-up and a PTT key-release. The data can be voice, video, or audio. A contact identifier can identify a mobile device performing the PTT key-up and a PTT key-release. A contact identifier can be retrieved from push-to-transmit (PTX) data such as an iCard or event message provided through PoC systems. The processor can identify other mobile devices that acquire the talk channel, and generate a contact identifier for the other mobile devices. The contact identifier can include a name of a user of the mobile device, a time the talk channel is acquired, and a length of the PTT recorded segment. The processor can playback the marked PTT conversation by contact identifier or by call session. In playback by call identifier, the processor can sort the marked PTT conversation by contact identifier, and play back the PTT recorded segments by contact in order of recording, in response to a request. In playback by call session, the processor can visually or audibly present a contact identifier of each PTT recorded segment. The mobile device can include a text-to-speech engine for synthesizing a voice tag from a contact identifier and pre-appending the voice tag to a PTT recorded segment. This allows the user to audibly identify the talker of the PTT recorded segment in marked PTT conversation.

### BRIEF DESCRIPTION OF THE DRAWINGS

The features of the system, which are believed to be novel, are set forth with particularity in the appended claims. The embodiments herein, can be understood by reference to the following description, taken in conjunction with the accompanying drawings, in the several figures of which like reference numerals identify like elements, and in which:

FIG. 1 is a block diagram of a wireless communication system in accordance with the embodiments of the invention;

FIG. 2 is a block diagram of a mobile device for data capture in accordance with the embodiments of the invention;

FIG. 3 is an in-call screen for visually identifying a talker in accordance with the embodiments of the invention;

FIG. 4 is a method for data capture in accordance with the embodiments of the invention;

FIG. 5 is an exemplary push-to-talk (PTT) conversation in accordance with the embodiments of the invention;

FIG. 6 is a depiction of the PTT conversation of FIG. 5 in accordance with the embodiments of the invention;

FIG. 7 is a marked PTT conversation in accordance with the embodiments of the invention;

FIG. 8 is a method for playback based on contact identifier in accordance with the embodiments of the invention;

FIG. 9 is a depiction of PTT recorded segments for a contact identifier in accordance with the embodiments of the invention;

FIG. 10 is a playback of data based on contact identifier in accordance with the embodiments of the invention;

FIG. 11 is a method for playback based on call session in accordance with the embodiments of the invention;

FIG. 12 is a depiction of a marked PTT conversation based on call session in accordance with the embodiments of the invention; and

FIG. 13 is a playback of data based on call session in accordance with the embodiments of the invention.

### DETAILED DESCRIPTION

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

The term “talk channel” can be defined as a transmit communication channel that is shared amongst a plurality of mobile devices. The term “hang-time” can be defined as the time between when a talk channel is released until the talk channel is again acquired. The term “PTT request” can be defined as an attempt to push to talk, either by hardware or software. The term “PTT key” can be defined as a physical button or a soft-key. The term “PTT key-up” can be defined as acquiring the transmit channel in response to a PTT request. The term “PTT key-release” can be defined as the releasing of the transmit channel in response to releasing the PTT key. The term “soft-key” can be defined as a software controlled button. The term “PTT group call” can be defined as a group call based on push-to-talk requests. The term “contact identifier” can be defined as a tag, or marking, associated with a PTT recorded segment that identifies a source of the data captured within the PTT recorded segment. The source can be a mobile device identifier, or a name of a user that is using the mobile device. The term “PTT recorded segment” can be defined as data that is captured on a talk channel between a PTT key-up and a PTT key-release. The term “playback by contact identifier” can be defined as replaying a recorded call session that only includes PTT recorded segments associated with the contact identifier. The term “playback by call session” can be defined as replaying a recorded call session with contact identifier information for at least one PTT recorded segment. The contact identifiers can be presented with their associated PTT recorded segments in a visual or audio format. The term “group dispatch call” can be defined as a continuous communication between a plurality of mobile device. The term “PTT conversation” can be defined as voice segments or data segments within a group dispatch call that are demarcated by a PTT key-up and a PTT key-release.

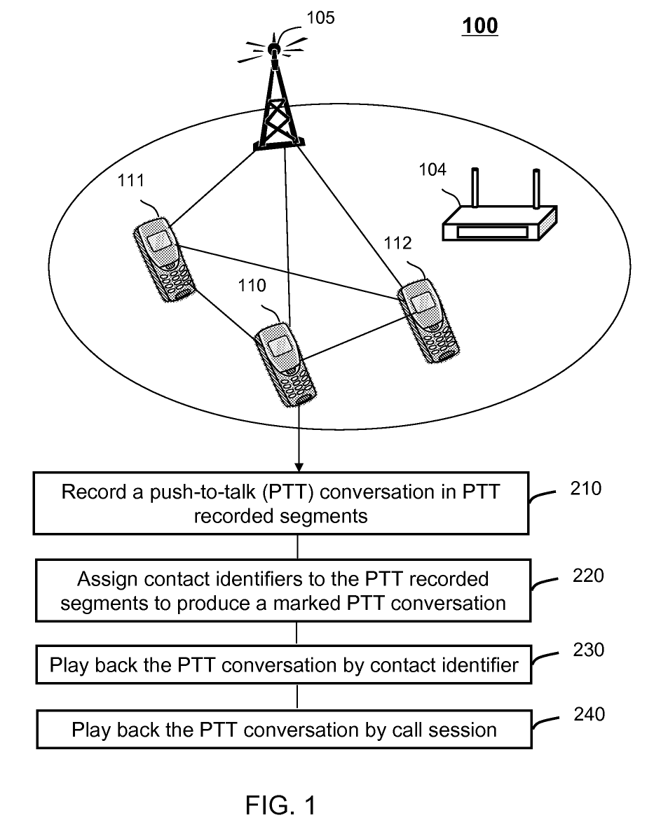

Referring to FIG. 1, a wireless communication system 100 for providing interconnect and dispatch communication is shown. The wireless system 100 can provide wireless connectivity or dispatch push-over-cellular (PoC) connectivity over a radio frequency (RF) communication network. The wireless communication system 100 can include a plurality of mobile devices 110-112 for providing voice communication. In one arrangement, the mobile devices 110-112 can communicate with one or more cellular towers 105 using a standard communication protocol such as CDMA, GSM, or iDEN, but is not herein limited to these. The cellular towers 105, in turn, can connect the mobile devices 110-112 through a cellular infrastructure to other mobile devices or resources on other networks (not shown). The cellular towers 105 can also connect to one or more servers for storing data, such as group dispatch calls, or more specifically, PTT conversations. As an example, the mobile device 110 can record a PTT conversation and save the PTT conversation locally to the mobile device 110, or to a server on the wireless communication system 100.

The mobile devices 110-112 can also connect amongst one another over a Wide Local Area Network (WLAN) 104 within an ad-hoc group. A WLAN provides wireless access within a local geographical area. The mobile devices 110-112 can communicate with the WLAN 104 according to the appropriate wireless communication standard. The WLAN 104 can coordinate a sending and receiving of voice packets between the mobile devices 110-112. In another arrangement, the mobile devices 110-112 can communicate amongst themselves in a peer-to-peer ad-hoc network without infrastructure or WLAN support. For example, the mobile devices can use short-range radio communication to engage in a group call in a peer-to-peer mode. In a typical WLAN implementation, the physical layer can use a variety of technologies such as 802.11b or 802.11g Wireless Local Area Network (WLAN) technologies. The physical layer may use infrared, frequency hopping spread spectrum in the 2.4 GHz Band, or direct sequence spread spectrum in the 2.4 GHz Band, or any other suitable communication technology.

Mobile devices 110-112 can communicate together in a group dispatch call over the push-to-cellular (PoC) wireless communication system 100. In the group dispatch call, there is only one talk channel. In dispatch mode, only one mobile device at a time can acquire the talk channel. When the talk channel is acquired, the mobile device can transmit data, such as voice or video, to the other mobile devices listening on the channel; that is, those devices engaged in the group dispatch call. It should be noted, that each mobile device can record the data sent on the talk channel from the other mobile devices during the PTT conversation. A mobile device can also record data sent by the mobile device itself.

Briefly, a mobile device, such as mobile device 110, can record the PTT conversation in PTT recorded segments (see 210). Each PTT recorded segment can be associated with a mobile device, or a user of the mobile device. The mobile device 110 can identify which of the other mobiles devices in the group dispatch call provide the data on the talk channel. In one arrangement, the mobile device 110 can identify mobile devices in response to a push-to-talk (PTT) request. The PTT request can include identifying information, such as a mobile identification, or a name of a user. In particular, participants engaging in a group dispatch call in a PoC system generally send identifying information with a PTT request. For example, in a PoC group call, every participant sends different push-to-transmit (PTX) data by PTT push. The mobile device 110 can review the PTX data to identify voice data associated with mobile device 111, and identify voice data associated with mobile device 112. The mobile device 110 can assign contact identifiers to the voice data based on the identification. In particular, the mobile device 110 can mark the PTT conversation with the contact identifiers (see 220). In practice, the mobile device 110 can determine which mobile devices are active on the talk channel. Upon marking the PTT conversation, the mobile device can retrieve data associated with a specific mobile device by the contact identifier. In one arrangement, the mobile device can playback data by contact identifier (see 230). In another arrangement, the mobile device can playback the PTT conversation by call session (see 240).

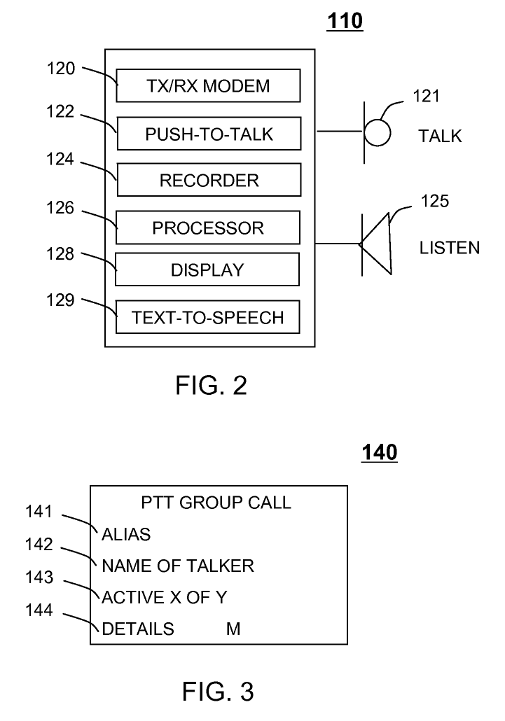

Referring to FIG. 2, a block diagram of a mobile device 110 is shown. The mobile device 110 can be a cell-phone, a personal digital assistant, a portable music player, an electronic map, a navigation system or any other suitable communication device. The mobile device 110 can include a modem 120 for providing transmit and receive communication during a group dispatch call, a push-to-talk (PTT) key 122 for acquiring a one-way dispatch voice communication over a transmit channel, a recorder 124 operatively coupled to the transmit channel for recording the group dispatch call in PTT recorded segments, a processor 126, or data-capture and information processing module, operatively coupled to the recorder 124 and the modem 120 for assigning contact identifiers to the PTT recorded segments, a display 128 for visually presenting contact identifiers associated with the PTT recorded segments, and a text-to-speech (TTS) engine 129 for converting contact identifiers to audio. The mobile device 110 can include a microphone 121 for capturing voice, or audio, and the speaker 125 for playing voice, or audio, as is known in the art.

Referring to FIG. 3, an in-call screen 140 is displayed. The in-call screen 140 can be presented on the display 140 during a playback of a marked PTT conversation. Briefly, the in-call screen 140 identifies a source of a PTT recorded segment of the PTT conversation. The in-call screen 140 can identify an alias 141, a name of the talker 142, a time statistic of talking activity 143, and details 144 associated with the contact identifier. Notably, the in-call screen 140 can change depending on which PTT recorded segment is being played. For example, different talkers can have different in-call screens which identify the name and the details for each PTT recorded segment. The in-call screen 140 can also be presented during the recording of the PTT conversation. This allows the first user to visually identify who is talking when recording or playing back the PTT conversation.

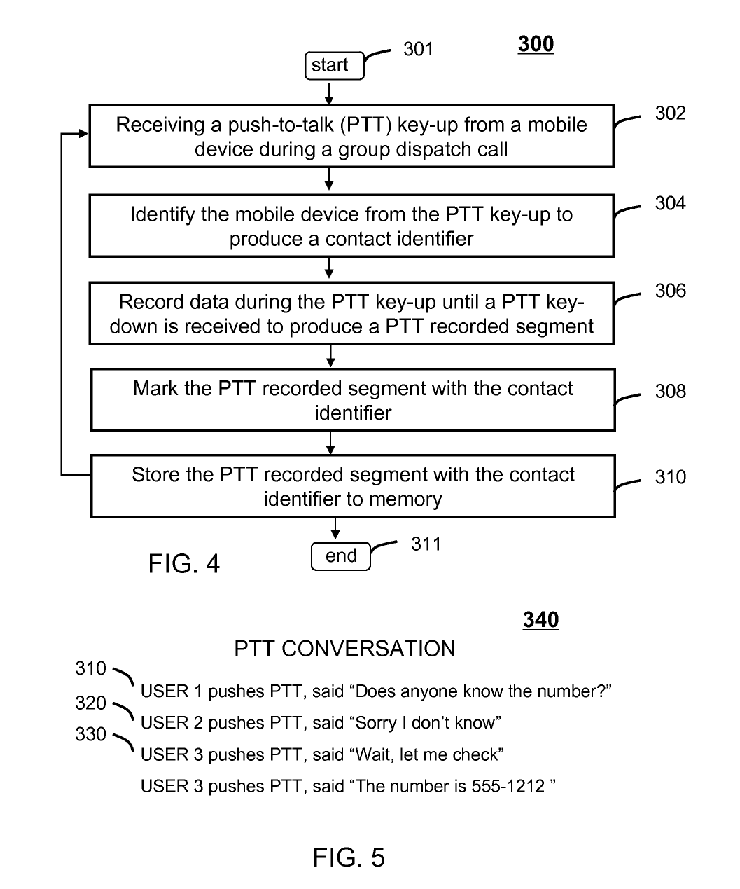

Referring to FIG. 4, a method 300 for data recording and playback for push-to-talk (PTT) group dispatch call is shown. Briefly, the method 300 can be practiced by a mobile device 110 of the wireless communication system 100 using a push-to-cellular (PoC) communication infrastructure as shown in FIG. 1. For example, the mobile device 110 of FIG. 2 can practice the method 300 for recording and playing back portions of, or an entire, PTT conversation. The method 300 can be practiced with more or less than the number of steps shown. To describe the method 300, reference will be made to FIGS. 1, 2, 5 and 6 although it is understood that the method 300 can be implemented in any other manner using other suitable components. In addition, the method 300 can contain a greater or a fewer number of steps than those shown in FIG. 4

At step 301, the method 300 can start. The method 300 can start in a state where one or more users are engaged in a group dispatch call. Each user can use a different mobile device. The method can start when at least one user elects to record a push-to-talk conversation. For example, referring to FIG. 1, a first user of a first mobile device 110 can press a soft-key to begin recording the PTT conversation. The PTT conversation can consist of the first user of the first mobile device 110, the second user of the second mobile device 111, and the third user of the third mobile device 112. Notably, more or less than three users can be in the group call.

At step 302, a push-to-talk (PTT) key-up can be received from a mobile device during a group dispatch call. The PTT key-up can acquire the talk channel of the group dispatch call. For example, referring back to FIG. 1, the first mobile device 110 can receive a PTT key-up from the second mobile device 111 or the third mobile device 112. The PTT key-up is received shortly after the second user presses the PTT key 122 to acquire the talk channel.

Referring to FIG. 5, an exemplary PTT conversation 340 is shown. The exemplary conversation 340 can include three talkers: User 1 (310) on mobile device 110, User 2 (320) on mobile device 111, and User 3 (330) on mobile device 112. A user can press a PTT key 122 of a respective mobile device to acquire the talk channel. As shown, the PTT conversation 340 can consist of PTT voice segments, though other data, such as video or audio, can also be transmitted on the talk channel. Notably, only one user can speak at a time on the talk channel during group dispatch call. A user can talk after pushing a PTT key. Phrases of the PTT conversation are shown in FIG. 5. In the exemplary PTT conversation, a first user 310 asks the other users for a phone number. The second user 320 does not have the number. The third user 330 makes a first response, then a second response identifying the number.

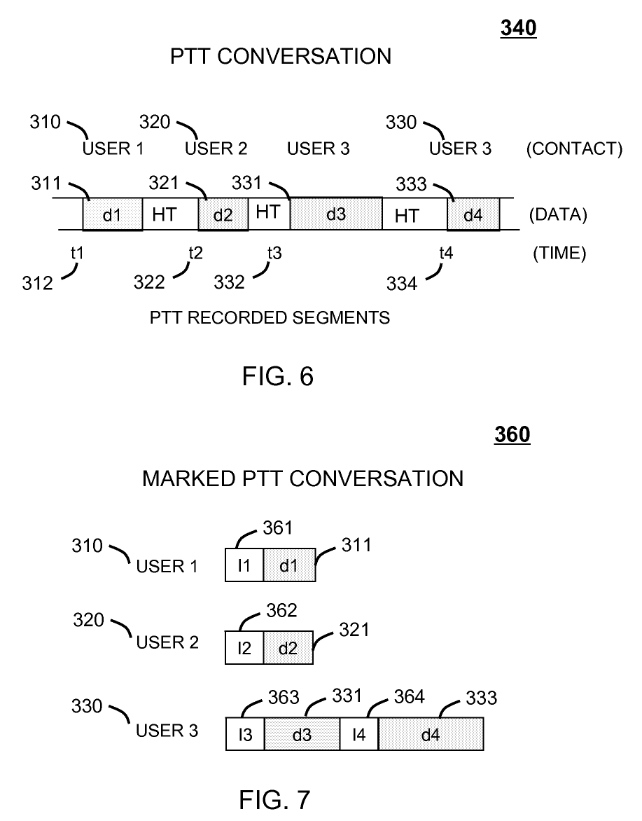

Referring to FIG. 6, a depiction of the PTT conversation 340 is shown. The depiction shows the PTT voice segments as blocks of data with specific time intervals. Each PTT voice segment has an associated start time and end time, corresponding to the PTT key-up and the PTT key-release, respectively. The time in between PTT voice segments is the hang-time, which is generally silence, and is designated by the initials (HT). However, the hang-time intervals may also include push-to-transmit (PTX) data. At a first time 312, User 1 (310) can push the PTT button and say the phrase d1 (311) “Does anyone know the number”. At a second time 322, User 2 (320) can push the PTT and say the phrase d2 (321) “Sorry, I don't know”. At a third time 332, User 3 (330) can push the PTT and say the phrase 331 “Wait, let me check”. At a fourth time 334, User 3 (330) can push the PTT and say the phrase d4 (333) “The number is 555-1212”. The phrases d1-d4 constitute data and are not restricted to only voice. For example, the user may send an image or a video during the PTT which can also be recorded and marked in memory.

Referring back to FIG. 4, at step 304, a mobile device can be identified from the PTT key-up. Notably, only one mobile device at a time can acquire the talk channel. The talk channel is acquired when the user presses the PTT key 122 and successfully acquires a transmit channel for the group dispatch call. In PoC group dispatch, a mobile device may send an information packet that identifies the mobile device. The information packet may also identify the user that is presently talking on the talk channel. As an example, the mobile device can send an iCard or descriptive identifier to inform other mobile devices of the person who is talking. Accordingly, the mobile device 110 can retrieve the descriptive identifier and determine which mobile device has acquired the talk channel. For example, referring to FIG. 2, the modem 120 can identify when a talk channel is acquired by another mobile device. The processor 126 can decode data packets received by the modem 120 to identify the mobile device that acquired the talk channel. The processor 120 can generate a contact identifier for the mobile device. Upon identifying the mobile device, a contact identifier can be produced. In practice, the mobile device 110 can generate a contact identifier for each mobile device in the PTT group dispatch call.

Returning back to FIG. 4, at step 306, data can be recorded during the PTT key-up and the PTT key-release to produce a PTT recorded segment. Recall in FIG. 1, the first mobile device 110 can capture the PTT conversation of the group dispatch call in PTT recorded segments. In particular, referring back to FIG. 2, the recorder 124 can capture and save the data on the talk channel. The processor 126 can inform the recorder 124 when to start and stop recording based on the PTT key-up and PTT key-release times. Only data that is communicated on the talk channel is captured. Silence intervals, such as a hang-time between a PTT key-release and a PTT key-up, are not recorded.

Returning back to FIG. 4, at step 308, the PTT recorded segment can be marked with the contact identifier. The contact identifier identifies the mobile device, or user, of the PTT recorded segment as discussed in step 304. A contact identifier can be a name of a contact, such as the user of the mobile device, a call session name of the PTT conversation, a time of the PTT recorded segment, or a length of the PTT recorded segment, but is not limited to these. As previously mentioned, the contact identifier can be generated from an information packet sent with the PTT key press, or with a PTX packet. Referring to FIG. 2, the processor 126 can mark a PTT recorded segment with the contact identifier. As illustrated in FIG. 7, the processor 126 can append the contact identifier to the PTT recorded segment. For instance, the contact identifier can be stored in memory before the PTT recorded segment. For example, contact identifier I1 (361) can be stored with PTT recorded segment d1 (331). In another arrangement, a pointer can be appended with the PTT recorded segment. The pointer can lead to another memory space containing the contact information.

Returning back to FIG. 4, at step 310, the PTT recorded segments can be saved with the contact identifier to memory. The memory can be local to the mobile device or available over a network connection. For example, referring back to FIG. 1, the first mobile device 110 can store marked PTT segments to a local memory on the phone, or to a server on the wireless communication network 100. In such regard, the PTT conversation can be made available to other participants. Referring to FIG. 2, the processor 126 can save the marked PTT recorded segment to memory. Notably, the processor 126 can generate multiple marked PTT recorded segments for each mobile device engaged in the PTT group dispatch call. Accordingly, the method 300 can return to step 302 to continue recording the PTT conversation. The method 300 can end when the user that initiated the recording of the PTT conversation ends the recording, or the group dispatch call. The method can end at step 311.

Referring to FIG. 7, a marked PTT 360 conversation is shown. In one arrangement, the marked PTT conversation can be stored in memory as shown. The marked PTT conversation 360 corresponds to the PTT conversation 340 of FIG. 6. In particular, the marked PTT conversation 360 includes contact identifiers appended to each PTT recorded segment. It should be noted, that the contact identifiers do not have to be appended to each PTT recorded segment. In another arrangement, the PTT recorded segments can be categorized by contact identifier.

Notably, the marked PTT conversation 360 is a result of a mobile device performing the method 300 of FIG. 4 for the PTT conversation 340. The marked PTT conversation 360 includes PTT recorded segments with contact identifiers. The marked PTT conversation 360 individually identifies users and their associated PTT recorded segments. For example, User 1 (310) is associated with PTT recorded segment d1 (311) through contact identifier I1 (361). User 2 (320) is associated with PTT recorded segment d2 (321) through contact identifier I2 (362). User 3 (330) is associated with PTT recorded segment d3 (331) through contact identifier I2 (363), and PTT recorded segment d4 (333) through contact identifier I4 (364). The marked PTT conversation 360 can be stored in local memory on the mobile device or on a server in the network.

In one arrangement, the mobile device can play the marked PTT conversation back by contact identifier. For example, upon completion of the PTT dispatch group call, a first user may desire to retrieve all PTT recorded segments associated with a second user. The first user, can enter a contact identifier of the second user, and the processor 126 can play back only the PTT recorded segments associated with the second user. In another arrangement, the mobile device can play the PTT conversation back by call session. In this case, each PTT recorded segment can be played back with a corresponding contact identifier. A contact identifier for each PTT recorded segment can be visually or audibly presented. The identifier may be suppressed for PTT recorded segments having the same user. That is, a contact identifier can be provided only when the PTT recorded segment corresponds to a different user, or mobile device.

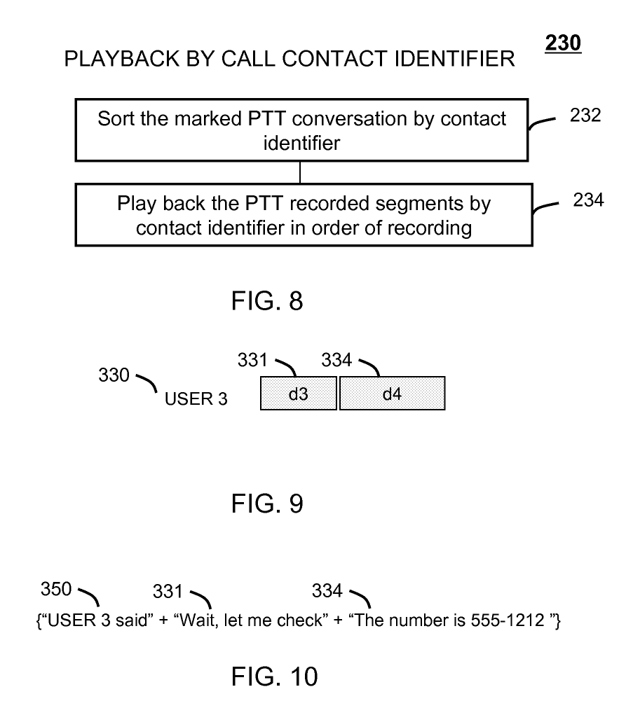

Referring to FIG. 8, a method 230 for playback by call identifier is shown. Briefly, the mobile device 110 can practice the method 230 to retrieve PTT recorded segments from the marked PTT conversation 360 by contact identifier. For instance, a first user may remember a second user saying a phrase, but not remember a particular date of the group dispatch call, or when the user said the phrase in the PTT conversation. In such regard, the user can specify the name of the second user, and the mobile device can automatically retrieve PTT recorded segments from a marked PTT conversation. This allows the first user to listen to voice recordings of only the second user. The first user is thus not required to listen to the entire PTT conversation during playback. Reference will also be made to FIG. 7, for describing the method 230.

At step 232, the marked PTT conversation can be sorted by contact identifier. As an example, with respect to the PTT conversation 340 of FIG. 5, User 1 (310) may request to play back only PTT recorded segments associated with User 3 (330). Recall, each PTT recorded segment was marked with a contact identifier during recording, as shown in FIG. 7. Accordingly, the mobile device can identify PTT recorded segments by the contact identifier. The processor 126 can identify PTT recorded segment 311 from contact identifier 363, and PTT recorded segment 331 from contact identifier 364. Referring to FIG. 9, the processor selects only the PTT recorded segments associated with User 3 (330). In another arrangement, PTT recorded segments from the same user can be grouped together for each contact identifier. A single voice recording can be created for each user. In such regard, a user can access the separate voice recordings directly, without referring to the marked PTT conversation 360. For example, the mobile device store voice recordings for different users separately. Instead of entering a contact identifier, the user can select the voice recordings by user name.

Returning back to FIG. 8, at step 234 the PTT recorded segments can be played back by contact identifier in order of recording. For example, upon identifying the PTT recorded segments for User 3 (330), the processor 126 can playback the PTT recorded segments for User 3 (330) in the time order captured. The processor 126 can also pre-append a contact identifier to the playback to identify the user. For example, as shown in FIG. 10, the processor 126 can append the audible phrase “User 3 said” (350) to the voice recorded data “Wait, let me check” (311) and “The number is 555-1212” (331). The user of the mobile device will hear “User 3 said, Wait, let me check, The number is 555-1212”. In such regard, the user is able to access only the PTT recordings of a specific user, by contact identifier. Moreover, only the PTT recorded segments associated with the contact identifier are played back to the user.

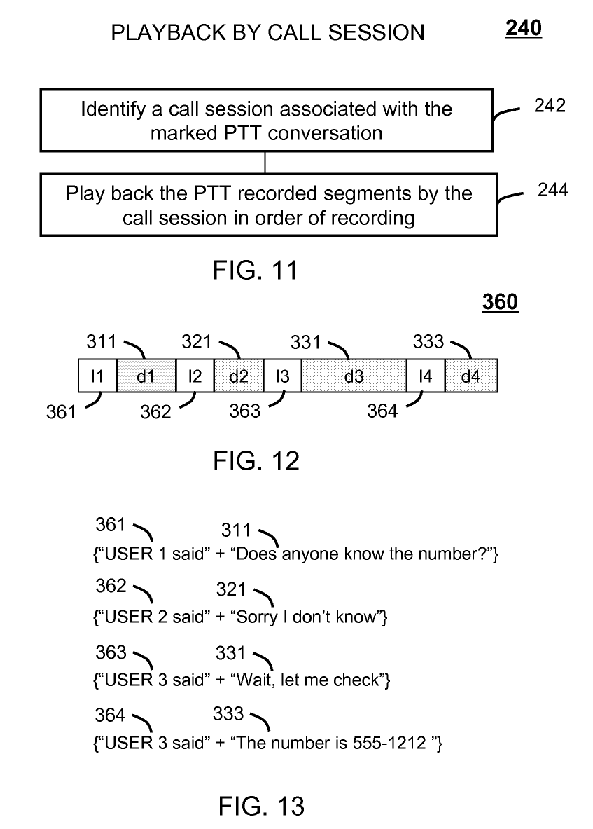

Referring to FIG. 11, a method 240 for playback by call session is shown. Briefly, a mobile device can practice the method 240 to replay the entire PTT conversation with contact identifiers. In playback by call session, visual or auditory indicators can be presented with each PTT recorded segment. For example, during playback, the name of a talker of a PTT recorded segment can be visually presented on a display. As another example, the name can be synthesized to voice and pre-appended to the PTT recorded segment to identify, or introduce, the talker. This allows the first user to determine who is talking during playback of the marked PTT conversation. Reference will also be made to FIG. 7, for describing the method 240.

At step 242, a call session associated with a marked PTT conversation can be identified. A call session is a description for a PTT conversation. For example, a user, upon recording a PTT conversation can save the marked PTT conversation under a filename. The filename identifies the call session and can be presented in the display of the mobile device. For example, referring back to FIG. 2, the mobile device 110 can present a list of call sessions on the display 126. A user can pick from one of the call sessions listed. Accordingly, the processor 126 can retrieve the marked PTT conversation associated with the call session.

Referring to FIG. 12, the marked PTT conversation 360 of FIG. 7, is shown in an appropriate time order. That is, each of the PTT recorded segments are presented in the same order as they were recorded. Notably, each PTT recorded segment also has an associated contact identifier. The contact identifier can identify a name of the talker for the PTT recorded segment, a length of the PTT recorded segment 333, a start time of the PTT recorded segment, or any other details associated with the PTT recorded segment.

Returning back to FIG. 11, at step 244, the PTT recorded segments of the call session can be played back in order of recording. Moreover, the contact identifier associated with each PTT recorded segment can be presented for each PTT recorded segment as the call session is played back. As one example, referring back to FIG. 2, the text to speech engine 129 can synthesize a voice tag from a contact identifier. The voice tag may be a user name retrieved from the contact identifier. The voice tag can be pre-appended to the PTT recorded segment to identify the talker. For example, referring to FIG. 13, the first PTT recorded segment can include a pre-appended voice tag (361) “User 1 said” followed by the PTT recorded segment “Does anyone know the number?”. Similarly, the second PTT recorded segment can include a pre-appended voice tag (362) “User 2 said” followed by the PTT recorded segment “Sorry, I don't know”. The third and fourth PTT recorded segment can be similarly constructed by pre-appending a voice tag. In such regard, each PTT recorded segment can be preceded by an indicator, or an introduction, to the talker if the PTT recorded segment. The playback of the call session can be “USER 1 said, Does anyone know the number, USER 2 said, Sorry I don't know, USER 3 said, Wait, let me check, The number is 555-1212”. The processor 126 can also insert pauses between PTT recorded segments to provide more natural sounding speech. Notably, the processor 126 can also suppress a contact identifier for a consecutive talker. For example, the third user is only introduced once, since the last two PTT recorded segments were both by the third user.

In another arrangement, the contact identifier can be visually presented. For example, referring back to FIG. 2, the processor 126 can present a name of the talker, from the contact identifier, on the display 128. More specifically, referring to FIG. 4, the name of the talker 142 can be visually presented on the in-call screen 140 of the display 128 Notably, the in-call screen 140 can present attributes of the contact identifier for each PTT recorded segment during playback. Accordingly, a user can visually identify the talker of a PTT recorded segment during a playback of the marked PTT conversation. The processor 126 can also present any other data associated with the contact identifier captured during the recording of the PTT conversation. For example, in a PoC group call, every participant can send different Push-to-talk (PTX) data, such as an iCard or event, in response to pressing of the PTT key 122. The processor 126 can save the PTX data to memory, and present the data during playback in the in-call screen 140. This also allows the user to retrieve the PTX data during the playback. For example, during the PTT conversation, a user may transmit an image for other users to see. Accordingly, the processor 126 can store the image, which can be made available for retrieval during playback.

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiment of the invention is not so limited. Numerous modifications, changes, variations, substitutions and equivalents will occur to those skilled in the art without departing from the spirit and scope of the present embodiments of the invention as defined by the appended claims.

What is claimed is:

1. A method for voice record and playback in push-over-cellular (PoC), the method comprising:
recording a PTT conversation in PTT recorded segments;
identifying mobile devices from (PTT) key-ups during the PTT conversation to produce contact identifiers;
assigning the contact identifiers to the PTT recorded segments to produce a marked PTT conversation; and
saving the marked PTT conversation to memory, wherein a PTT recorded segment is a portion of the PTT conversation captured between a PTT key-up and a PTT key-release.

2. The method of claim 1, further comprising identifying a user of a mobile device from push-to-transmit (PTX) data such as an iCard or an event message.

3. The method of claim 1, further comprising:
receiving a contact identifier;
sorting the marked PTT conversation by the contact identifier; and
playing back PTT recorded segments associated with the contact identifier in order of recording.

4. The method of claim 1, further comprising:
identifying a call session associated with the marked PTT conversation; and
playing back the PTT recorded segments in order of recording, wherein at least one PTT recorded segment is preceded by a contact identifier.

5. The method of claim 1, further comprising visually presenting a contact identifier on a display during a playback of a PTT recorded segment.

6. The method of claim 1, further comprising audibly presenting a contact identifier by pre-appending a voice tag to a PTT recorded segment during a playback of a PTT recorded segment.

7. The method of claim 1, wherein a contact identifier is a name of a user, an alias, a mobile device identifier, a talk activity indicator, a call session name of the PTT conversation, a time of the PTT recorded segment, or a length of the PTT recorded segment.

8. The method of claim 1, wherein the step of recording a push-to-talk PTT group call further comprises:
receiving a request to record a PTT conversation;
identifying a PTT key-up from a mobile device in the PTT conversation;
identifying the mobile device performing the PTT key-up; and
capturing data associated with the PTT key-up.

9. The method of claim 1, wherein the data is voice, video, image, picture, or audio that is shared and captured during the PTT conversation.

10. A method for call session recording and playback in Push-over-Cellular (PoC), comprising:
receiving a push-to-talk (PTT) key-up from a first mobile device during a group dispatch call;
identifying the first mobile device from the PTT key-up to produce a first contact identifier;
recording data during the PTT key-up until a PTT key-down is received to produce a PTT recorded segment;
marking the PTT recorded segment with the contact identifier;
storing the first PTT recorded segment to memory; and
repeating the steps of receiving, identifying, recording, marking, and storing for a plurality of mobile devices on the group dispatch call for producing a marked PTT conversation having multiple PTT recorded segments.

11. The method of claim 10, further comprising:
receiving a request to retrieve PTT recorded segments, the request providing a contact identifier; and
presenting the PTT recorded segments for the contact identifier in order of recording in response to the request.

12. The method of claim 10, further comprising:
identifying a call session associated with the marked PTT conversation; and
playing back the PTT recorded segments by the call session in order of recording, wherein at least one PTT recorded segment is preceded by a contact identifier.

13. The method of claim 12, wherein the playing back further comprises pre-appending a voice tag on a PTT recorded segment.

14. The method of claim 12, wherein the playing back further comprises visually displaying a contact identifier during a PTT recorded segment.

15. The method of claim 10, wherein a contact identifier is a name of the contact, a name of the PTT conversation, a time of the PTT recorded segment, a length of the PTT recorded segment.

16. A mobile device for call session recording and playback, comprising:
a push-to-talk (PTT) key that acquires a talk channel and communicates data during a PTT group call;
a recorder operatively coupled to the talk channel that records the PTT group call in PTT recorded segments, wherein a PTT recorded segment is a recording of data between a time of a PTT key-up and a PTT key-release; and
a processor operatively coupled to the recorder that assigns contact identifiers to the PTT recorded segments to produce a marked PTT conversation, wherein a contact identifier identifies a mobile device performing the PTT key-up and a PTT key-release.

17. The mobile device of claim 16, wherein the processor identifies other mobile devices that acquire the talk channel, and generates a contact identifier for the other mobile devices, wherein the contact identifier includes a name of a user of the mobile device, a time the talk channel is acquired, and a length of the PTT recorded segment.

18. The mobile device of claim 16, wherein the processor sorts the marked PTT conversation by contact identifier, and plays back the PTT recorded segments associated with the contact identifier in order of recording.

19. The mobile device of claim 16, further comprising:
a display operatively coupled to the processor that visually shows a contact identifier associated with a PTT recorded segment

20. The mobile device of claim 16, further comprising:
a text-to-speech engine operatively coupled to the processor that pre-appends a voice tag on a PTT recorded segment.
